(19) United States
(12) Patent Application Publication
(10) Pub. No.: US 2009/0290041 A1
(43) Pub. Date: Nov. 26, 2009

(54) Image processing device and method, and computer readable recording medium containing program

(75) Inventor: Masaya Tamaru, Kurukawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fujifilm Corporation, Tokyo (JP)

(21) Appl. No.: 12/453,602

(22) Filed: May 15, 2009

(30) Foreign Application Priority Data
May 20, 2008 (JP) 131802/2008

(51) Int. Cl. H04N 5/228; H04N 5/232; G06K 9/40

(52) U.S. Cl. 348/222.1; 382/255; 348/E05.031; 348/345; 348/E05.045

(57) ABSTRACT

An image processing device includes: an image obtaining unit for obtaining an image; a depth of field specification unit for receiving specification of a depth of field specified by an imager size; and a blur enhancement processing unit for generating a processed image with enhanced blur of a subject contained in the image, the blur being enhanced according to the specified depth of field.

### BACKGROUND OF THE INVENTION

1. Field of the Invention

The present invention relates to an image processing device and an image processing method for obtaining an image having different depths of field from more than one images of the same scene having different focused focal positions, and a computer readable recording medium containing a program for causing a computer to carry out the image processing method.

2. Description of the Related Art

Among imaging devices such as a digital camera, one provided with a depth of field correction function has been known. With this function, more than one images of the same scene which are respectively focused on the foreground and the background are obtained, and an omnifocal image focused on a plurality of subjects contained in the scene or an image having different degrees of blur of the subjects, such as the foreground and the background, i.e., an image having different depths of field, is generated from these images through image processing.

Using the depth of field correction function, an image with a shallow depth of field, such as one taken with a single-lens reflex camera provided with a large image pickup device, can be obtained even with a compact-type camera having a small image pickup device.

Further, a technique for use with an imaging device provided with the depth of field correction function, which allows obtaining an image having a specified focused focal position and a specified degree of blur by receiving specification of the focused focal position and the degree of blur by the user, has been proposed (see U.S. Patent Application Publication No. 20020060748). According to this technique, an image having a degree of blur desired by the user, i.e., an image having a desired depth of field can be obtained.

In a case where a subject, such as a person, is photographed with a film camera, use of a larger film size can provide an image having a shallower depth of field, in which the background of the focused person is highly blurred. Therefore, the photographer can have empirical knowledge of the depth of field of a photographed image depending on the size of the film used. A digital camera having a larger image pickup device can also provide an image having a shallower depth of field and a higher degree of blur of the background.

An imaging device provided with the depth of field correction function, as is disclosed in the above-mentioned patent document, allows the user to directly specify the focused focal position and the degree of blur. However, it is not easy for the user to know correspondence between the degree of blur of an obtained image and the size of the film or the image pickup device (hereinafter referred to as imager) and to know correspondence between the depth of field and the imager size.

### SUMMARY OF THE INVENTION

In view of the above-described circumstances, the present invention is directed to allowing the user to empirically specify a depth of field of an image, which is provided by modification through image processing.

An aspect of the image processing device according to the invention includes: an image obtaining unit for obtaining an image; a depth of field specification unit for receiving specification of a depth of field specified by an imager size; and a blur enhancement processing unit for generating a processed image with enhanced blur of a subject contained in the image, the blur being enhanced according to the specified depth of field.

In the image processing device according to the invention, the image obtaining unit may include an imaging unit for obtaining more than one images by carrying out more than one photographing operations to take a same scene with different focused focal positions, and the blur enhancement processing unit may generate the processed image from the more than one images.

In the image processing device according to the invention, the depth of field specification unit may receive the specification of the depth of field by receiving selection of an imager size selected from a list of various imager sizes.

In the image processing device according to the invention, the blur enhancement processing unit may generate the processed image with a higher degree of blur enhancement for a shallower depth of field specified by the imager size.

An aspect of the image processing method according to the invention includes: obtaining an image; receiving specification of a depth of field specified by an imager size; and generating a processed image with enhanced blur of a subject contained in the image, the blur being enhanced according to the specified depth of field.

The present invention may also be implemented in the form of a recording medium containing a program for causing a computer to carry out the image processing method according to the invention.

### BRIEF DESCRIPTION OF THE DRAWINGS

FIG. 1 is a schematic block diagram illustrating the configuration of a digital camera, to which an image processing device according to an embodiment of the present invention is applied,

FIG. 2 is a diagram illustrating the configuration of an imaging unit,

FIG. 3 is a diagram for explaining focus bracket imaging,

FIG. 4 is a flow chart illustrating operations carried out in the embodiment,

FIG. 5 is a flow chart of a distance image generation process,

FIG. 6 is a diagram illustrating a distance image,

FIG. 7 is a diagram illustrating an imager size selection screen,

FIG. 8 is a flow chart of a blur enhancement process,

FIG. 9 illustrates a Gaussian filter, and

FIG. 10 illustrates a relationship between an imager size I and a coefficient a.

### DESCRIPTION OF THE PREFERRED EMBODIMENTS

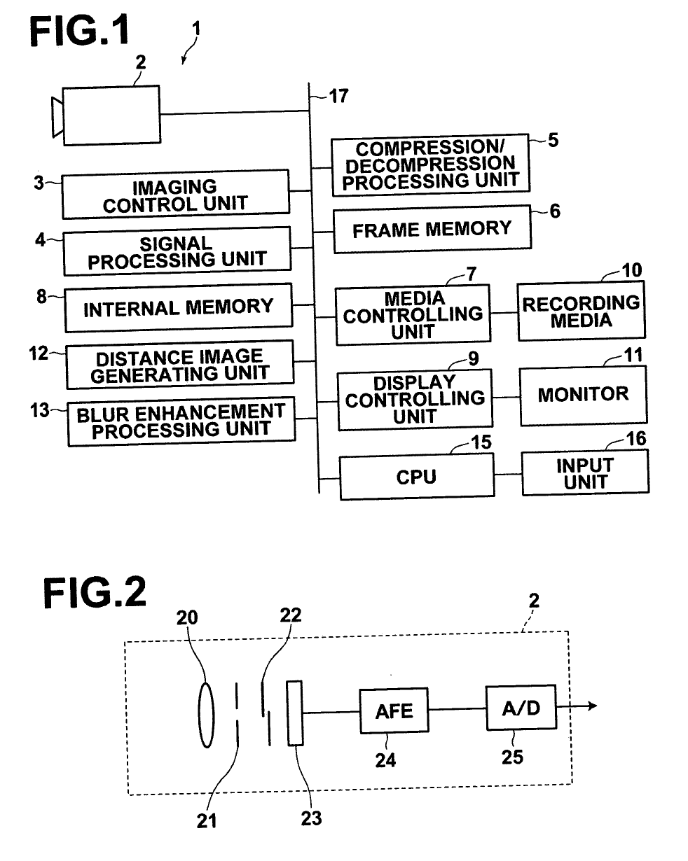

Hereinafter, an embodiment of the present invention will be described with reference to the drawings. FIG. 1 is a schematic block diagram illustrating the configuration of a digital camera, to which an image processing device according to the embodiment of the invention is applied. As shown in FIG. 1, a digital camera 1 according to this embodiment includes an imaging unit 2, an imaging control unit 3, a signal processing unit 4, a compression/decompression processing unit 5, a frame memory 6, a media controlling unit 7, an internal memory 8 and a display controlling unit 9.

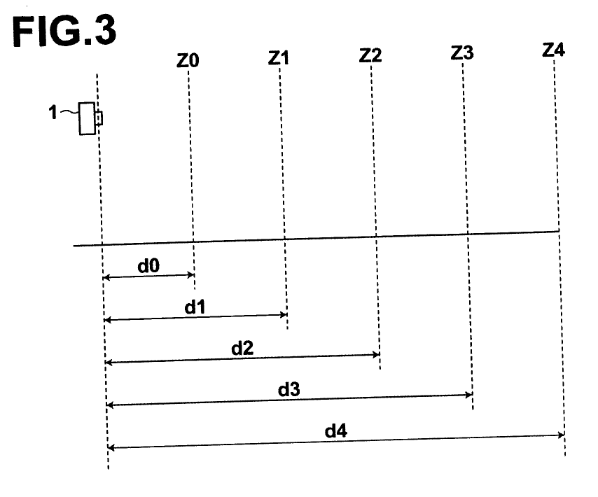

FIG. 2 illustrates the configuration of the imaging unit 2. As shown in FIG. 2, the imaging unit 2 includes a lens 20, a diaphragm aperture 21, a shutter 22, a CCD 23, an analog front end (AFE) 24 and an A/D conversion unit 25.

The lens 20 is formed by a plurality of lenses having their respective functions, such as a focusing lens for focusing on a subject and a zooming lens for effecting a zooming function, and the position of each lens is adjusted by a lens driving unit (not shown). For example, the lens driving unit adjusts the focal position of the focusing lens.

The aperture diameter of the diaphragm aperture 21 is adjusted by a diaphragm aperture driving unit (not shown) based on aperture value data obtained through AE processing.

The shutter 22 is a mechanical shutter, and is driven by a shutter driving unit (not shown) according to a shutter speed obtained through the AE processing.

The CCD 23 includes a photoelectric surface having a predetermined size, on which a large number of light-receiving elements are arranged two-dimensionally. A light image of the subject is focused on the photoelectric surface and is subjected to photoelectric conversion to obtain an analog imaging signal. Further, a color filter formed by regularly arrayed R, G and B color filters are disposed on the front side of the CCD 23.

The AFE 24 processes the analog imaging signal outputted from the CCD 23 to remove noise from the analog imaging signal and adjust gain of the analog imaging signal (hereinafter, this operation is referred to as “analog processing”).

The A/D conversion unit 25 converts the analog imaging signal, which has been subjected to the analog processing by the AFE 24, into a digital imaging signal. It should be noted that the image data which is obtained by converting the analog imaging signal obtained at the CCD 23 of the imaging unit 2 into the digital imaging signal is raw data, which includes R, G and B density values for the individual pixels.

The imaging control unit 3 controls an imaging operation after a release button is pressed. Further, when the release button is half-pressed, the imaging control unit 3 carries out AF processing and the AE processing to set the focal position of the focusing lens, the aperture value data and the shutter speed. It should be noted that, in a state where the release button is not pressed, the imaging control unit 3 controls the imaging unit 2 to take a live view image. Furthermore, in this embodiment, after the release button is pressed, the imaging control unit 3 controls the imaging unit 2 to carry out focus bracket imaging to obtain more than one images having different focused focal positions by taking more than one images with changing the focal position of the focusing lens.

FIG. 3 is a diagram for explaining the focus bracket imaging. Here, a case where five images having different focused focal positions are taken is described. As the release button is half-pressed, the imaging control unit 3 carries out the AF processing to determine the focused focal position in the scene to be photographed. Specifically, AF evaluation values (for example, output values from a band-pass filter) are calculated for preliminary images which are obtained when the release button is half-pressed, and the focal position of the focusing lens which provides the highest AF evaluation value is determined as the focused focal position.

Then, the focused focal position determined through the AF processing is used as a reference to determine two positions at predetermined distances from the reference in forward and backward directions from the reference (i.e., four positions in total), which are used as focal positions of the focusing lens for carrying out the focus bracket imaging. Assuming that a position Z2 shown in FIG. 3 is the focused focal position determined through the AF processing, the position Z2, two positions Z0 and Z1 in front of the position Z2 and two positions Z3 and Z4 behind the position Z2 are used as the focused focal positions for the focus bracket imaging. Subject distances, each representing a distance from the center of the lens of the digital camera 1 to each focused focal position, for the focused focal positions Z0-Z4 are d0-d4, respectively.

It should be noted that the focal positions may be positions which are at predetermined distances from the reference focused focal position determined through the AF processing in forward and backward directions, as described above, or the focal positions maybe altered depending on the aperture value during photographing, a focal length of the lens, etc. Information of the focal positions is stored in the internal memory 8, which will be described later. The information of each focal position may be written in a tag of each photographed image.

In the images obtained by the focus bracket imaging, each corresponding pixel at the same position in each image represents information of the same subject contained in the photographed scene.

The signal processing unit 4 applies signal processing, such as white balance adjustment, tone conversion, sharpness correction and color correction, to the digital image data of the image obtained by the imaging unit 2.

The compression/decompression processing unit 5 applies compression processing according to a certain compression format, such as JPEG, to the image data, which has been processed by the signal processing unit 4, to generate an image file. A header describing accompanying information, such as photographing time and date, is added to the image file, based, for example, on the Exif format.

The frame memory 6 provides a workspace for various processing, including the processing by the signal processing unit 4, applied to the image data representing the image obtained by the imaging unit 2.

The media controlling unit 7 accesses a recording medium 10 and controls writing and reading of the image file into and from the recording medium 10.

The internal memory 8 stores various constants to be set in the digital camera 1, programs to be executed by the CPU 15, etc.

The display controlling unit 9 causes the image data stored in the frame memory 6 or the image recorded in the recording medium 10 to be displayed on a monitor 11.

The digital camera 1 further includes a distance image generating unit 12 and a blur enhancement processing unit 13. Details of processes carried out by the distance image generating unit 12 and the blur enhancement processing unit 13 will be described later.

The CPU 15 controls various units of the digital camera 1 according to signals inputted via an input unit 16 including a four-directional key, various operation buttons and the release button.

The data bus 17 is connected to the respective units and the CPU 15 forming the digital camera 1 to communicate various data and various information in the digital camera 1.

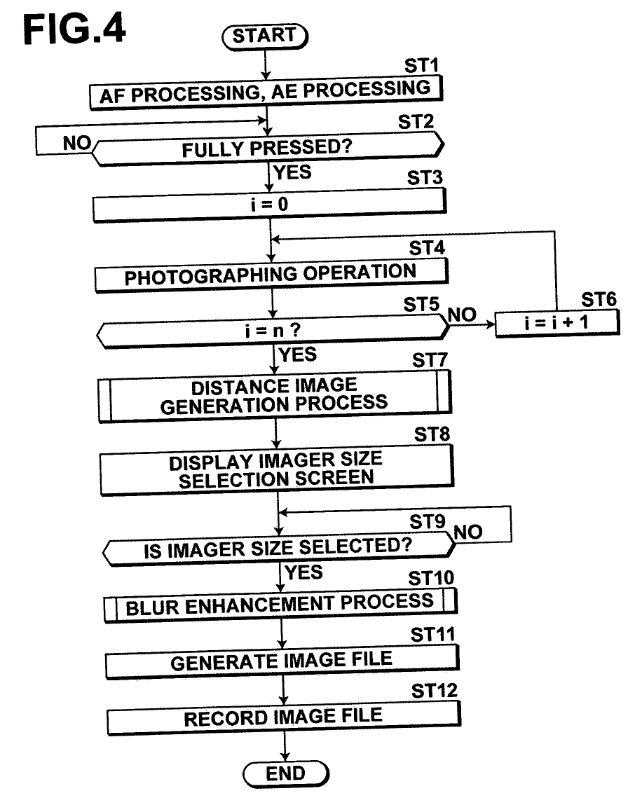

Next, operations carried out in this embodiment are described. FIG. 4 is a flow chart illustrating the operations carried out in this embodiment. It should be noted that, here, operations which are carried out after the release button is half-pressed are described.

As the release button is half-pressed, the imaging control unit 3 carries out the AF processing and the AE processing (step ST1). Through this AF processing, the focal positions of the focusing lens used for the focus bracket imaging are determined. Then, when the release button is fully pressed (YES in step ST2), the CPU 15 first sets an initial value for the focal position (i=0 in step ST3), and a photographing operation is carried out (step ST4). In this case, the focusing lens included in the lens 20 is driven by the lens driving unit to provide the set focal position. In this manner, an image Gi focusing at the subject distance corresponding to the set focal position is obtained.

Then, the CPU 15 determines whether or not the photographing operation has been carried out for all the focal positions (i=n in step ST5). If the determination in step ST5 is negative, the next focal position is set (i=i+1 in step ST6), and the process returns to step ST4. Each image Gi obtained by the photographing operation is sequentially subjected to the signal processing by the signal processing unit 4 and is recorded in the internal memory 8. The image Gi taken with the focused focal position determined through the AF processing is referred to as the reference image. For example, when the focus bracket imaging is carried out as shown in FIG. 3, the image G2 is the reference image.

If the determination in step ST5 is affirmative, the distance image generating unit 12 generates a distance image D0, which is formed by pixels representing distance information, from the images Gi (step ST7).

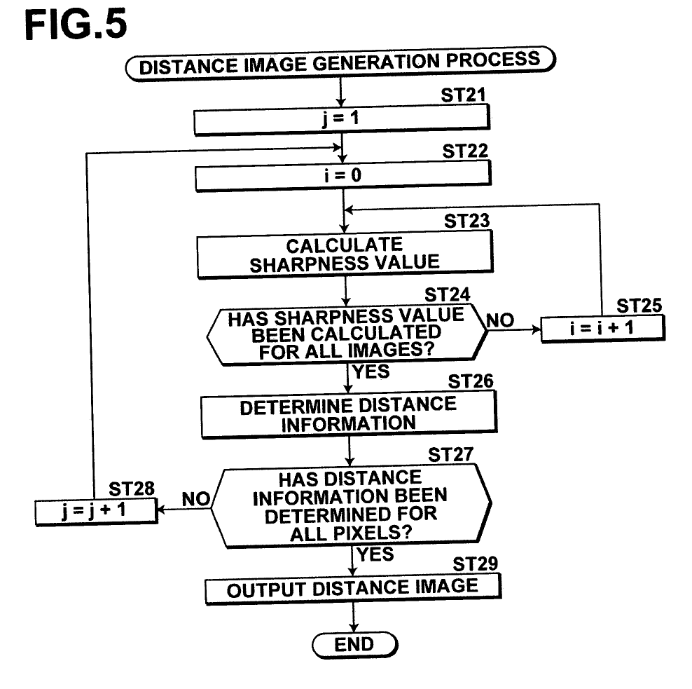

FIG. 5 is a flow chart of a distance image generation process. The distance image generating unit 12 first sets the first pixel as a pixel of interest Pj, for which the distance is determined (j=1 in step ST21). It should be noted that each pixel position in the image Gi is represented by two-dimensional coordinates; however, in this description, the pixel position is represented one-dimensionally for the sake of simplicity. Then, the distance image generating unit 12 sets the first image as the image to be processed (i=0 in step ST22), and the image Gi is read out from the recording medium 10. Then, the pixel of interest Pj of the image Gi is filtered with a high-pass filter, such as a Laplacian filter, and the absolute value of an output of the filtering is calculated as a sharpness value of the pixel of interest Pj (step ST23). It should be noted that the technique which may be used for calculating the sharpness value is not limited to the filtering with a high-pass filter.

Then, determination is made as to whether or not the sharpness value has been calculated for all the images Gi (step ST24). If the determination in step ST24 is negative, the next image is set as the image to be processed (i=i+1 in step ST25), and the process returns to step ST23. If the determination in step ST24 is affirmative, the reference symbol (0-4) of one of the images Gi having the largest sharpness value is determined as distance information dx of the pixel of interest Pj (step ST26). That is, the distance information dx of the pixel of interest Pj is to select the most focused image Gi at the pixel of interest Pj.

Then, the distance image generating unit 12 determines whether or not the distance information dx has been determined for all the pixels (step ST27). If the determination in step ST27 is negative, the next pixel is set as the pixel of interest (j=j+1 in step ST28), and the process returns to step ST22. Then, operations in step ST22 and the following steps are repeated.

If the determination in step ST27 is affirmative, the distance image generating unit 12 outputs the distance image D0 formed by the pixels representing the distance information dx (step ST29), and the distance image generation process ends.

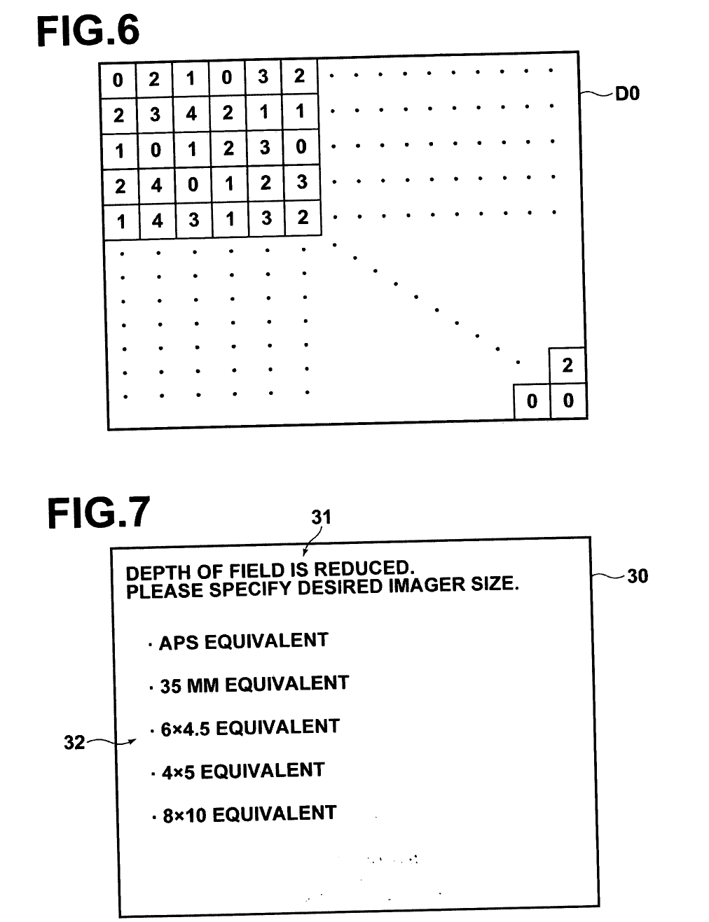

FIG. 6 shows the distance image. As shown in FIG. 6, each pixel of the distance image D0 carries the reference symbol of the determined image Gi as the distance information.

Returning to FIG. 4, the CPU 15 displays an imager size selection screen on the monitor 11 (step ST8). FIG. 7 shows the imager size selection screen. As shown in FIG. 7, the imager size selection screen 30 contains a text 31 of a message “Depth of field is reduced. Please specify desired imager size” and a list 32 of specifiable imager sizes. In the example of the imager size selection screen shown in FIG. 7, sizes “APS equivalent”, “35 mm equivalent”, “6×4.5 equivalent”, “4×5 equivalent” and “8×10 equivalent” are available as the imager size.

In general, use of a larger imager provides an image with a shallower depth of field, in which subjects other than the focused subject are highly blurred. In this embodiment, the user can select a depth of field for a processed image, which is obtained as will be described later, from the list 32 displayed on the imager size selection screen 30.

As the imager size is selected (YES in step ST9), the blur enhancement processing unit 13 applies a blur enhancement process to the reference image according to the imager size (step ST10).

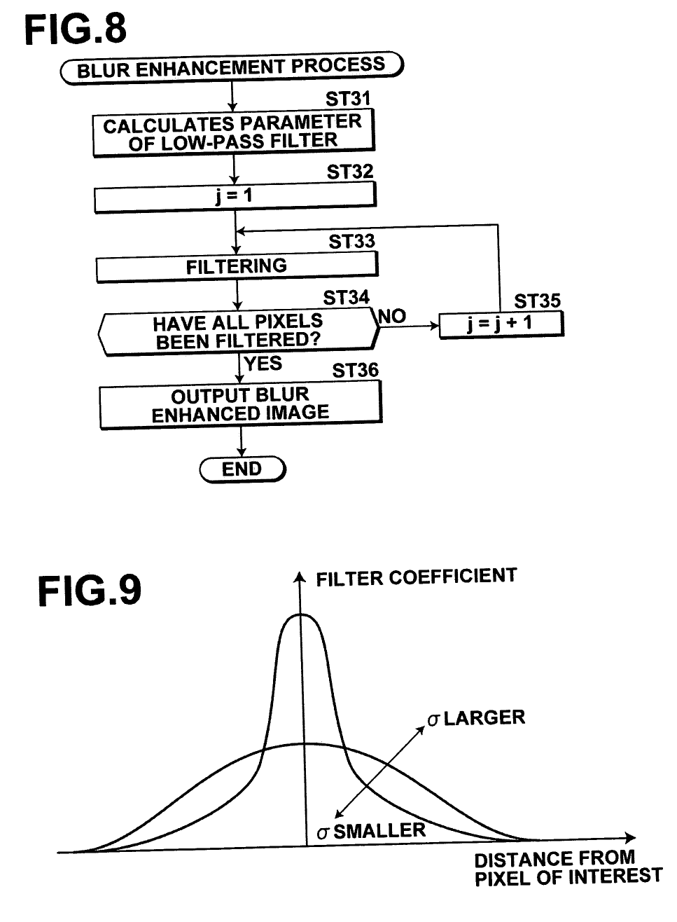

FIG. 8 is a flow chart of the blur enhancement process. The blur enhancement processing unit 13 first calculates a parameter of a low-pass filter used to carry out the blur enhancement process for each pixel of the reference image (step ST31). Now, calculation of the parameter is described. In this embodiment, a Gaussian filter is used as the low-pass filter.

The blur enhancement processing unit 13 obtains the information of the focal positions of the images Gi, and calculates a parameter a of the Gaussian filter for each pixel of the reference image according to equation (1) below. It should be noted that each pixel position in the reference image is represented by two-dimensional coordinates; however, in this description, the pixel position is represented one-dimensionally for the sake of simplicity.

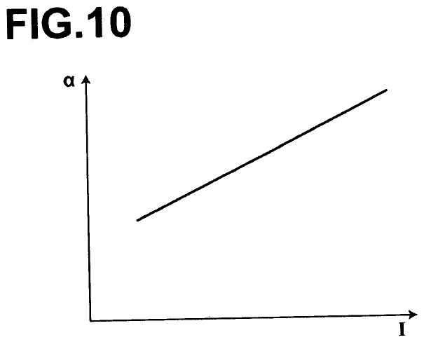

FIG. 9 is a two-dimensional representation of the Gaussian filter. As shown in FIG. 9, the Gaussian filter has a filter coefficient which provides a larger degree of blur of the processed image for a larger parameter σ.

σj=α/F·|pj−pb| (1)

wherein, σj is a parameter for the pixel of interest Pj for which the parameter is calculated, F is an F value during a photographing operation, pj is a focal position of the image corresponding to the distance information dx at the pixel of interest Pj, and pb is the focused focal position determined through the AF processing, i.e., the focal position of the reference image. Further, α is a coefficient which is determined according to the imager size by referencing a table stored in the internal memory 8. FIG. 10 shows the table representing a relationship between the coefficient a and the imager size I. As shown in FIG. 10, the table is set to provide a larger value of the coefficient α for a larger value of the imager size I. It should be noted that more than one tables may be prepared depending on the focal length during a photographing operation.

Calculating the parameter σj of the Gaussian filter in this manner, the parameter σj of 0 is provided for a pixel carrying the distance information dx which is equivalent to the distance information of the reference image, and a lager parameter σj is provided for a pixel carrying the distance information dx which differs from the distance information of the reference image by a larger degree.

Subsequently, the blur enhancement processing unit 13 sets the first pixel in the reference image as the pixel of interest Pj to be subjected to the blur enhancement process (j=1 in step ST32). Then, the blur enhancement processing unit 13 carries out filtering using the Gaussian filter having the calculated parameter σj for the pixel of interest Pj (step ST33). Since the parameter σj is 0 for the pixels where the distance information dx is equivalent to the distance information of the reference image, those pixels are actually not subjected to the filtering. Then, the blur enhancement processing unit 13 determines whether or not all the pixels have been filtered (step ST34). If the determination in step S34 is negative, the next pixel is set as the pixel of interest (j=j+1 in step ST35), and the process returns to step ST33. Then, operations in step ST33 and the following steps are repeated.

If the determination in step ST34 is affirmative, a blur enhanced image, which is formed by pixels having pixel values of the filtered pixels of the reference image, is outputted (step ST36), and the blur enhancement process ends. In the blur enhanced image, a subject at the subject distance of the reference image is focused, and the other subjects are blurred such that the larger the distance from the subject distance of the reference image, the higher the degree of blur.

Returning to FIG. 4, the compression/decompression processing unit 5 generates an image file of the blur enhanced image (step ST11), the media controlling unit 7 records the image file in the recording medium 10 (step ST12), and the process ends.

As described above, in this embodiment, the specification of the depth of field specified by the size of the imager used for photographing an image is received. In this manner, the user can specify the depth of field based on the empirical knowledge of the imager sizes, and can obtain an image having a desired depth of field which is empirically known from the imager size.

It should be noted that, although the coefficient α is determined by referencing the table shown in FIG. 10 in the above-described embodiment, this is not intended to limit the invention. The coefficient α may be calculated using, for example, a diagonal length of the imager having the specified imager size.

Further, although the imager size is selected on the imager size selection screen which is displayed after the focus bracket imaging has been carried out and the distance image has been generated in the above-described embodiment, the imager size may be selected before the photographing operation, and the blur enhancement process may be carried out immediately after the distance image has been generated.

Furthermore, although the depth of field is specified by allowing the user to select a desired imager size on the imager size selection screen in the above-described embodiment, the imager size may directly be inputted to the digital camera 1 by the user using the input unit 16 to specify the depth of field.

Moreover, although the images Gi are obtained by the focus bracket imaging and the distance image is generated using the images Gi in the above-described embodiment, a stereo camera provided with more than one imaging units may be used to photograph a subject, and each corresponding pixel between the thus obtained images may be searched using a stereo matching technique. Then, the distance image may be generated by measuring a distance from the stereo camera to a point on the subject corresponding to each pixel by applying the principle of the triangulation method to the corresponding pixels of the images. Alternatively, the distance image may be generated by measuring a distance from the camera to the subject by measuring a time between emission of measurement light, such as near-infrared light, toward the subject and reception the light reflected by the subject. In these cases, it is sufficient to obtain one image to carry out the blur enhancement process.

Further, although the blur enhancement process according to the imager size is applied to the photographed image in the above-described embodiment, the image to be subjected to the blur enhancement process is not limited to a photographed image. For example, the blur enhancement process according to the imager size may be applied to an image created using a computer graphics technique in the similar manner to the above-described embodiment.

The image processing device 1 according to the embodiment of the invention has been described. However, the present invention may also be implemented in the form of a program for causing a computer to function as means corresponding to the distance image generating unit 12 and the blur enhancement processing unit 13 to carry out the operations shown in FIGS. 4, 5 and 8. The present invention may also be implemented in the form of a computer-readable recording medium containing the program.

### Effect of the Invention

According to the invention, specification of a depth of field specified by an imager size is received, and a processed image is generated with blur of a subject contained in the image being enhanced according to the specified depth of field. This allows the user to specify the depth of field based on empirical knowledge of the imager sizes, thereby obtaining an image having a desired depth of field which is empirically known from the imager size.

What is claimed is:

1. An image processing device comprising:
an image obtaining unit for obtaining an image;
a depth of field specification unit for receiving specification of a depth of field specified by an imager size; and
a blur enhancement processing unit for generating a processed image with enhanced blur of a subject contained in the image, the blur being enhanced according to the specified depth of field.

2. The image processing device as claimed in claim 1, wherein
the image obtaining unit comprises an imaging unit for obtaining more than one images by carrying out more than one photographing operations to take a same scene with different focused focal positions, and
the blur enhancement processing unit generates the processed image from the more than one images.

3. The image processing device as claimed in claim 1, wherein the depth of field specification unit receives the specification of the depth of field by receiving selection of an imager size selected from a list of various imager sizes.

4. The image processing device as claimed in claim 1, wherein the blur enhancement processing unit generates the processed image with a higher degree of blur enhancement for a shallower depth of field specified by the imager size.

5. An image processing method comprising:
obtaining an image;
receiving specification of a depth of field specified by an imager size; and
generating a processed image with enhanced blur of a subject contained in the image, the blur being enhanced according to the specified depth of field.

6. A computer readable recording medium containing a program for causing a computer to carry out an image processing method, the method comprising:
obtaining an image;
receiving specification of a depth of field specified by an imager size; and
generating a processed image with enhanced blur of a subject contained in the image, the blur being enhanced according to the specified depth of field.
